(19) United States
(12) Patent Application Publication
(10) Pub. No.: US 2025/0329319 A1
(43) Pub. Date: Oct. 23, 2025

(54) PROCESS FOR ASSEMBLING SOUND-ABSORBING PANELS AND SOUND-ABSORBING PANEL

(71) Applicant: IMPACT ACOUSTIC AG, Lucerna (CH)

(72) Inventors: Sven ERNI, Cham (CH); Jeffrey IBANEZ, Zurich (CH)

(21) Appl. No.: 19/069,348

(22) Filed: Mar. 4, 2025

(30) Foreign Application Priority Data
Apr. 22, 2024 (IT) 102024000009088

(51) Int. Cl. G10K 11/16

(52) U.S. Cl. CPC G10K 11/16

(57) ABSTRACT

Process for assembling sound-absorbing panels (1), comprising the steps of arranging at least one sound-absorbing panel (1) at a wall to be soundproofed (A), the panel (1) having a contact surface (2) contacting the wall (A) and an externally visible surface (3) opposite said contact surface (2); cutting the visible outer surface (3) to define at least one portion (4) of the panel (1) movable in relation to the rest of the panel (1); moving the portion (4) away from the panel (1) by defining a blind cavity (5) formed in the outer surface (3); inserting a screw (6) inside said cavity (5) to pierce 10 the contact surface (2) until the screw (6) is inserted into the wall (A); and then moving the portion (4) closer to the panel (1) to insert the portion (4) itself inside the cavity (5).

### CROSS REFERENCE TO RELATED APPLICATIONS

This application claims the benefit of and priority to IT patent application Ser. No. 10/202,4000009088, flied Apr. 22, 2024, the entire disclosure of which is hereby incorporated herein by reference.

### BACKGROUND

As is known, sound-absorbing panels, also called acoustic panels, are engaged to the surfaces of an environment which is to be soundproofed. Such panels, which can be rigid or semi-rigid depending on the sound-absorbing materials with which they are made, can be engaged to both vertical walls and to the ceiling of the environment to be soundproofed. In particular, for assembling very light and flexible panels, adhesive elements are used which are sufficient to ensure that the panels are held in place.

### SUMMARY

The present invention relates to a process for assembling sound-absorbing panels. The invention further relates to a sound-absorbing panel provided with a respective engagement system to a respective wall surface.

Sound-absorbing panels, also called acoustic panels, can be engaged to the surfaces of an environment which is to be soundproofed. Such panels, which can be rigid or semi-rigid depending on the sound-absorbing materials with which they are made, can be engaged to both vertical walls and to the ceiling of the environment to be soundproofed. In particular, for assembling very light and flexible panels, adhesive elements are used which are sufficient to ensure that the panels are held in place.

However, for assembling more rigid and heavier panels, mechanical anchoring systems are adopted which allow to provide greater stability, preventing the panels from falling by gravity. For example, for coupling panels made of felt or similar material to vertical walls, clamping screws can be used, which are inserted from the externally visible surface of the panel and pierce the thickness of the panel itself, and insert in the wall. Thereby, the rear surface of the panel (not visible) is abutted to the wall, and the clamping screws, which can be positioned in the corners of a rectangular panel, for example, ensure a stable constraint of the aforementioned panels.

Generally, the screws are inserted inside holes preformed in the panel and positioned according to the shape and size of the panel itself. Once all the screws have been inserted, the hole obtained in the panel is suitably closed with a cap adapted to cover the screw head and ‘hide’ the presence of the hole. For this purpose, the cap has an outer surface which can be adapted to the graphic pattern of the panel, so as not to damage the graphic pattern and the aesthetic effect given by the visible surface of the panel. Furthermore, to secure the cap inside the hole, adhesive compounds can be used, which are distributed inside the hole and configured to anchor the cap to the panel.

However, the panel connection systems of the type described above have major drawbacks and application limitations. It should firstly be noted that the caps, although appropriately finished according to the individual panels to be anchored, are nevertheless externally visible and therefore damage the overall aesthetic value derived from the panels, which, in addition to their acoustic insulation features, can have particular aesthetic patterns and finishes.

In addition, during the various transport and installation operations of the panels, the caps can get lost and become damaged, with the consequent drawbacks in terms of functionality and, above all, the aesthetic value given by the entire panel. In this context, it should also be noted that installation operations are complicated by the need to provide appropriate closing caps of the holes obtained on the panels, as well as to correctly distribute the adhesive substances inside the hole.

Another major drawback is given by the presence of the adhesive substances which hold the cap inside the hole and thus do not allow to access the screw to detach the panel later. In other words, the known systems turn out to be irresolvable, since once the cap is in place, it is impossible to access the internal screw in order to detach the panel from the wall and thus maintain/replace the panels themselves. In this context, the panel must necessarily be broken in order to carry out the aforementioned maintenance operations.

Finally, another drawback of the prior art is the need to pre-drill the panel in order to make the aforementioned holes for housing the screws. Such an action is costly during panel production and is not very versatile, as it requires the screw to be positioned in relation to the panel.

In this context, the aim of the present invention is to provide a process for assembling sound-absorbing panels and a sound-absorbing panel capable of solving the drawbacks of the prior art described above. In particular, the aim of the present invention is to provide a simple, inexpensive and easy-to-implement process for stably anchoring the panels to any kind of wall surface.

A further aim of the present invention is to provide a panel and a respective assembly process which is capable of preserving the aesthetic features of the panel itself. In other words, the aim of the invention is to provide a process which does not damage or tamper with the graphic pattern, as well as the aesthetic appearance of the visible surface of the panel.

Another aim of the present invention is to provide a process for assembling sound-absorbing panels which does not require the use of adhesives or other external elements to be applied to the panel during assembly.

A further aim of the present invention is to provide an extremely versatile process which can be applied with any type of panel and without pre-drilling the panel in order to adapt the assembly operations according to specific needs.

Finally, an aim of the present invention is to provide a process and relative panel for reversibly mounting the panel from the wall and thus easily detachable for maintenance and replacement.

The specified technical task and the specified aims are substantially achieved by a process for assembling sound-absorbing panels and a sound-absorbing panel comprising the technical features set forth in the appended claims 1 and 8 and/or in one or more of the claims dependent thereon and/or in the appended description, respectively.

Further features and advantages of the present invention will become clearer from the indicative, and therefore non-limiting, description of a preferred embodiment of a process for assembling a sound-absorbing panel and a sound-absorbing panel.

### BRIEF DESCRIPTION OF THE DRAWINGS

A description will be set forth herein below with reference to the accompanying drawings, provided for merely indicative and therefore non-limiting purposes, wherein:

FIGS. 1 to 5 show perspective and schematic views of respective operating sequences for assembling a sound-absorbing panel on a wall; and

FIG. 6 shows a schematic side and sectional view of a sound-absorbing panel according to the present invention assembled on a respective wall to be soundproofed.

### DETAILED DESCRIPTION

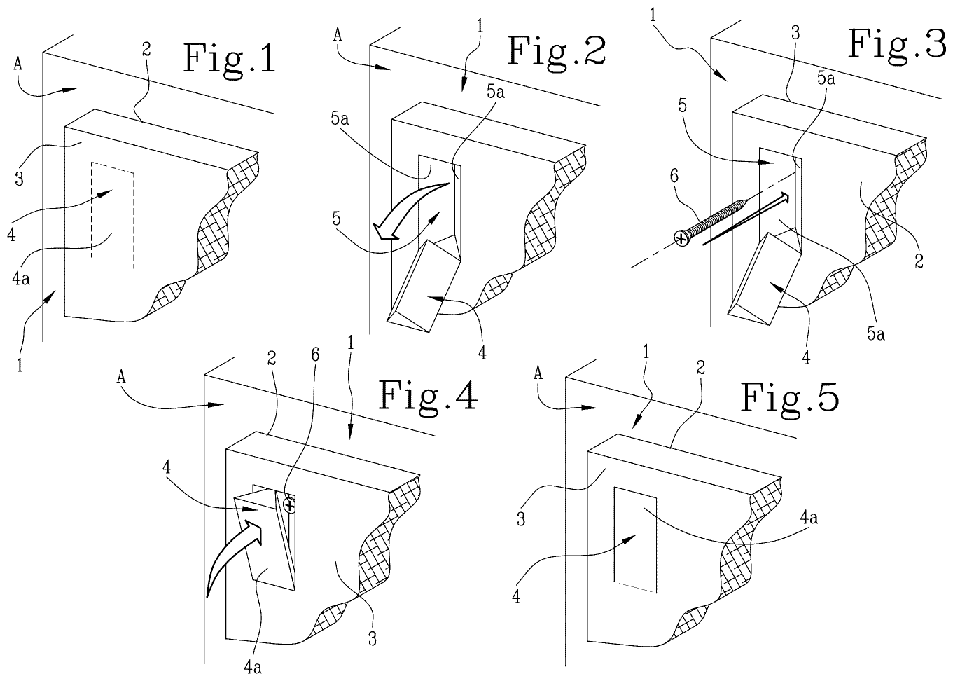

With reference to the accompanying figures, reference numeral 1 globally denotes a sound-absorbing panel according to the present invention. It should be specified that the sound-absorbing panel 1 can be of any size and structure. For illustrative purposes only, only a corner portion of the sound-absorbing panel 1 is illustrated in FIGS. 1 to 5.

In particular, the panel 1 comprising a contact surface 2 contacting a wall A to be soundproofed, and an externally visible surface 3 opposite the contact surface 2. Advantageously, the panel 1 comprises a portion 4 which is movable with respect to the panel 1 between a condition moved away from the panel 1 (FIGS. 2 to 4) to define a blind cavity 5 on the externally visible surface 3, and a condition moved closer to the panel 1 (FIGS. 1, 5 and 6) to be inserted into the aforementioned cavity.

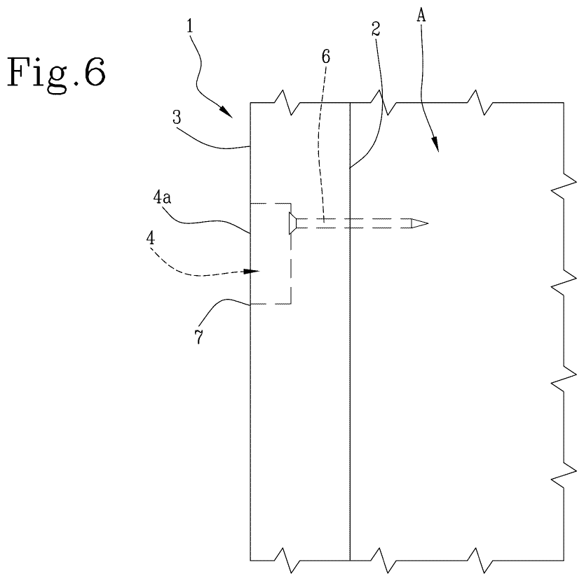

The portion 4 in the moved-away condition allows the insertion of a screw 6 inside the cavity 5 to couple the panel 1 to the wall A (FIG. 6), as will be better described below. The portion 4 is advantageously made integral with the panel 1. In other words, the portion 4 is made in the form of a part of the panel which can be partially separated from the rest of the panel 1 itself.

As shown in FIGS. 1 to 5, the panel 1 comprises a hinge line 7 which connects the portion 4 from the rest of panel 1. The hinge 7, made in the form of a folding line, allows the rotation of the portion 4 with respect to the panel 1 between the aforementioned moved-away and moved-closer conditions.

Preferably, the portion 4 comprises a substantially prismatic shape with a triangular cross-section. In this situation, one side of the triangular base of the prismatic shape defines the aforementioned hinge 7. Furthermore, an outer face of the prismatic shape defines an outer surface 4a of the portion 4 that is coplanar to the externally visible surface 3 in the moved-closer condition (FIGS. 1, 5 and 6). Consequently, the cavity 5 also comprises two side surfaces 5a converging towards an inner corner zone of the panel 1 adapted to receive the screw 6.

The present invention further relates to a process for assembling sound-absorbing panels 1, of the type described above in structural terms. The process comprises the step of arranging at least one sound-absorbing panel 1 at a wall to be soundproofed A. The panel 1 is arranged with the contact surface 2 against the wall A and thus leaving the externally visible surface 3 externally exposed.

Next, the visible outer surface 3 is cut to define the movable portion 4 in relation to the rest of the panel 1. The step of cutting the outer surface 3 is implemented by means of appropriate blades and other cutting systems and allows to separate the aforementioned part 4, connecting it from the rest of the panel 1 through the hinge line 7.

Advantageously, the step of cutting the panel 1 (FIG. 1) comprises the sub-step of making at least three notches on the outer surface 3 converging with each other. The three notches together with the hinge line 7 define a rectangle on the outer surface 3. Such a rectangle in turn defines the outer surface 4a of the portion 4 coplanar to the externally visible surface 3 of the entire panel 1 in the configuration of FIGS. 1 and 5.

As specified above, the notches converge towards the inside of the panel 1 to define the blind cavity 5 with the respective side surfaces 5a converging with each other and towards a corner zone configured to receive the screw 6. Consequently, the notches define the essentially prismatic shape with triangular cross-section of the portion 4, viz., the ‘wedge’ shape.

Next, the portion 4 is moved away from the panel 1 (FIG. 2) to access the blind cavity 5. This step is implemented by extracting the portion 4 from the panel 1, rotating the portion 4 itself around the hinge 7.

Next, the screw 6 is inserted inside the cavity 5 (FIG. 3). As is better illustrated in FIG. 6, the screw 6 is inserted from the corner zone of the cavity 5 to pierce the section of the panel 1 and insert into the wall A. The head of the screw 6, once inserted, remains housed in the cavity 5 (FIG. 4).

Next, the portion 4 is moved closer to the panel and inserted in the respective cavity 5 (FIGS. 4 and 5). This step of moving the portion 4 is also implemented by rotating the portion around the hinge 7 up to the total insertion of the portion 4 inside the cavity 5 wherein the outer surface 4a is coplanar with the externally visible surface 3 of the panel 1.

Thereby, the head of the screw 6 is covered and hidden by the portion 4. Advantageously, the process described above is particularly simple, inexpensive and easy to implement, as it only requires making the notches to define the portion 4 and the subsequent rotation thereof.

It should be noted in particular that the panel 1 and the respective assembly process preserves the aesthetic features of the panel 1 itself, as it does not damage or tamper with the graphic pattern, as well as the aesthetic appearance of the visible surface 3. Such an advantage is given by the fact that the portion 4 is obtained from the panel 1, which is therefore integral with the panel 1 and is free to rotate away from/closer to the cavity 5.

Another advantage of the present invention is given by the absence of outer elements or adhesives, thus simplifying the assembly steps, making them more economical and without any pre-drilling of the panel 1.

Finally, an important advantage derived from the absence of adhesive substances is the reversibility of the process, which allows, by accessing inside the cavity 5, to unscrew the screw, detach the panel 1 and implement any replacement and maintenance operations.

1. Process for assembling sound-absorbing panels, comprising:
arranging at least one sound-absorbing panel (1) at a wall to be soundproofed (A), the panel (1) having a contact surface (2) contacting the wall (A) and an externally visible surface (3) opposite said contact surface (2);
cutting the visible outer surface (3) to define at least one portion (4) of the panel (1) as movable in relation to the rest of the panel (1);
moving the portion (4) away from the panel (1) by defining a blind cavity (5) formed in the outer surface (3);
inserting a screw (6) into said cavity (5) to pierce the contact surface (2) until the screw (6) is inserted into the wall (A); and then
moving the portion (4) closer to the panel (1) to insert the portion (4) itself inside the cavity (5).

2. Process according to claim 1, wherein said portion (4) is made integral with the panel (1).

3. Process according to claim 1, wherein said step of cutting the outer surface (3) of the panel (1) defines a hinge line (7) of the portion (4) with the panel (1).

4. Process according to the claim 3, wherein said step of moving the portion (4) away from and/or closer to the panel (1) is implemented by rotating the portion (4) about the hinge line (7) between the condition wherein it is moved away from the panel (1) to define the cavity (5) and the condition wherein it is moved closer to the panel (1) to be inserted into the cavity (5).

5. Process according to claim 4, wherein said portion (4) inserted into the cavity (5) comprises an outer surface (4a) that is coplanar with the externally visible surface (3) of the panel (1).

6. Process according to claim 1, wherein said step of cutting the panel (1) comprises a sub-step of making at least three notches on the outer surface (3) converging with each other, said portion (4) having a substantially prismatic shape with a triangular cross-section.

7. Process according to claim 6, wherein said notches define a blind cavity (5) having side surfaces (5a) converging towards an inner zone of the panel (1); said screw (6) being inserted into said inner zone.

8. Sound-absorbing panel (1), comprising:
a contact surface (2) contacting a wall (A) to be soundproofed and an externally visible surface (3) opposite said contact surface (2); and
a portion (4) movable with respect to the panel (1) between a condition moved away from the panel (1) to define a blind cavity (5) on the externally visible surface (3) and a condition moved closer to the panel (1) to be inserted into said cavity (5), wherein
said portion (4) in the moved-away condition allowing the insertion of a screw (6) inside the cavity (5) to couple the panel (1) to said wall (A).

9. Panel according to claim 8, wherein said portion (4) is made integral with the panel (1).

10. Panel according to claim 8, further comprising a hinge line (7) between the portion (4) and the panel (1), said hinge line (7) allowing the rotation of the portion (4) with respect to the panel (1) between said moved-away and moved-closer conditions.

11. Panel according to claim 8, wherein said portion (4) comprises a substantially prismatic shape with a triangular cross-section.

12. Panel according to any one of claim 8, wherein said portion (4) comprises an outer surface (4a) coplanar to the externally visible surface (3) of the panel (1) in said moved-closer condition.

13. Panel according to claim 8, wherein said cavity (5) comprises two side surfaces (5a) converging towards an inner zone of the panel (1); said screw (6) being inserted into said inner zone.
